(19) United States
(12) Patent Application Publication
(10) Pub. No.: US 2004/0112727 A1
(43) Pub. Date: Jun. 17, 2004

(54) Laser cut channel plate for a switch

(76) Inventor: Marvin Glenn Wong, Woodland Park, CO (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/317,932

(22) Filed: Dec. 12, 2002

(51) Int. Cl. H01H 29/00

(52) U.S. Cl. 200/182

(57) ABSTRACT

Disclosed herein is a switch having a channel plate and a switching fluid. The channel plate defines at least a portion of a number of cavities, a first cavity of which is defined by a laser cut channel in the channel plate. The switching fluid is held within one or more of the cavities, and is movable between at least first and second switch states in response to forces that are applied to the switching fluid. Alternate switch embodiments, and a method for making a switch, are also disclosed.

### BACKGROUND

Channel plates for liquid metal micro switches (LIMMS) can be made by sandblasting channels into glass plates, and then selectively metallizing regions of the channels to make them wettable by mercury or other liquid metals. One problem with the current state of the art, however, is that the feature tolerances of channels produced by sandblasting are sometimes unacceptable (e.g., variances in channel width on the order of ±20% are sometimes encountered). Such variances complicate the construction and assembly of switch components, and also place limits on a switch's size (i.e., there comes a point where the expected variance in a feature's size overtakes the size of the feature itself).

### SUMMARY OF THE INVENTION

One aspect of the invention is embodied in a switch comprising a channel plate and a switching fluid. The channel plate defines at least a portion of a number of cavities, a first cavity of which is defined by a laser cut channel in the channel plate. The switching fluid is held within one or more of the cavities, and is movable between at least first and second switch states in response to forces that are applied to the switching fluid.

Another aspect of the invention is embodied in a method for making a switch. The method comprises 1) laser cutting at least one feature into a channel plate, and 2) aligning the at least one feature cut in the channel plate with at least one feature on a substrate and sealing at least a switching fluid between the channel plate and the substrate.

Other embodiments of the invention are also disclosed.

### BRIEF DESCRIPTION OF THE DRAWINGS

Illustrative embodiments of the invention are illustrated in the drawings, in which:

FIG. 1 illustrates an exemplary plan view of a channel plate for a switch;

FIG. 2 illustrates an elevation view of the FIG. 1 channel plate;

FIG. 3 illustrates the laser cutting of a channel plate feature into a channel plate;

FIG. 4 illustrates a first exemplary embodiment of a switch having a channel plate with laser cut channels therein;

FIG. 5 illustrates a second exemplary embodiment of a switch having a channel plate with laser cut channels therein;

FIG. 6 illustrates an exemplary method for making a fluid-based switch;

FIGS. 7 & 8 illustrate the metallization of portions of the FIG. 1 channel plate;

FIG. 9 illustrates the application of an adhesive to the FIG. 8 channel plate; and

FIG. 10 illustrates the FIG. 9 channel plate after laser ablation of the adhesive from the plate's channels.

### DETAILED DESCRIPTION OF THE INVENTION

When sandblasting channels into a glass plate, there are limits on the feature tolerances of the channels. For example, when sandblasting a channel having a width measured in tenths of millimeters (using, for example, a ZERO automated blasting machine manufactured by Clemco Industries Corporation of Washington, Mo., USA), variances in channel width on the order of ±20% are sometimes encountered. Large variances in channel length and depth are also encountered. Such variances complicate the construction and assembly of liquid metal micro switch (LIMMS) components. For example, channel variations within and between glass channel plate wafers require the dispensing of precise, but varying, amounts of liquid metal for each channel plate. Channel feature variations also place a limit on the sizes of LIMMS (i.e., there comes a point where the expected variance in a feature's size overtakes the size of the feature itself).

In an attempt to remedy some or all of the above problems, switches with laser cut channel plates, and methods for making same, are disclosed herein. It should be noted, however, that the switches and methods disclosed may be suited to solving other problems, either now known or that will arise in the future.

When channels are laser cut into a channel plate, variances in channel width for channels measured in tenths of millimeters (or smaller) can be reduced to about ±3% using the methods and apparatus disclosed herein.

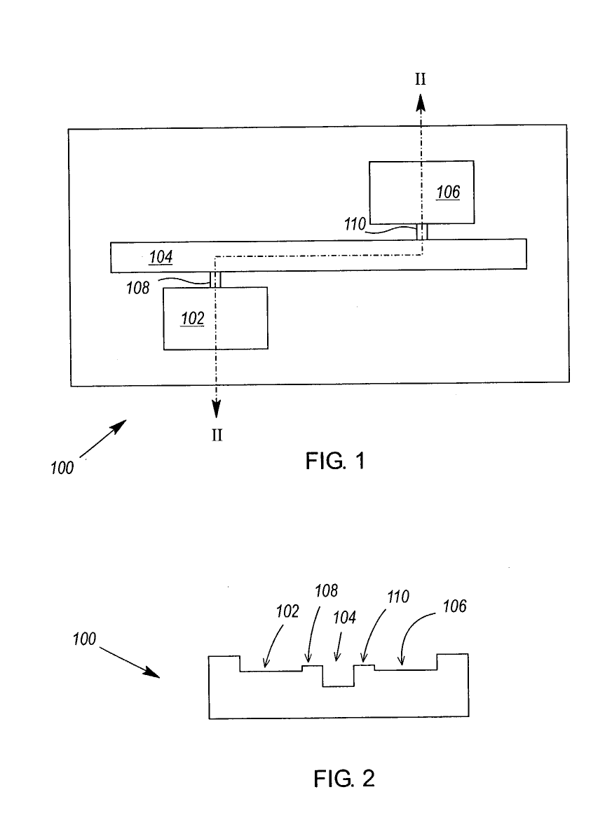

FIGS. 1 & 2 illustrate a first exemplary embodiment of a channel plate 100 for a fluid-based switch such as a LIMMS. By way of example, the features that are formed in the channel plate 100 comprise a switching fluid channel 104, a pair of actuating fluid channels 102, 106, and a pair of channels 108, 110 that connect corresponding ones of the actuating fluid channels 102, 106 to the switching fluid channel 104 (NOTE: The usefulness of these features in the context of a switch will be discussed later in this description.). The switching fluid channel 104 may have a width of about 200 microns, a length of about 2600 microns, and a depth of about 200 microns. The actuating fluid channels 102, 106 may each have a width of about 350 microns, a length of about 1400 microns, and a depth of about 300 microns. The channels 108, 110 that connect the actuating fluid channels 102, 106 to the switching fluid channel 104 may each have a width of about 100 microns, a length of about 600 microns, and a depth of about 130 microns.

It is envisioned that more or fewer channels may be formed in a channel plate, depending on the configuration of the switch in which the channel plate is to be used. For example, and as will become more clear after reading the following descriptions of various switches, the pair of actuating fluid channels 102, 106 and pair of connecting channels 108, 110 disclosed in the preceding paragraph may be replaced by a single actuating fluid channel and single connecting channel.

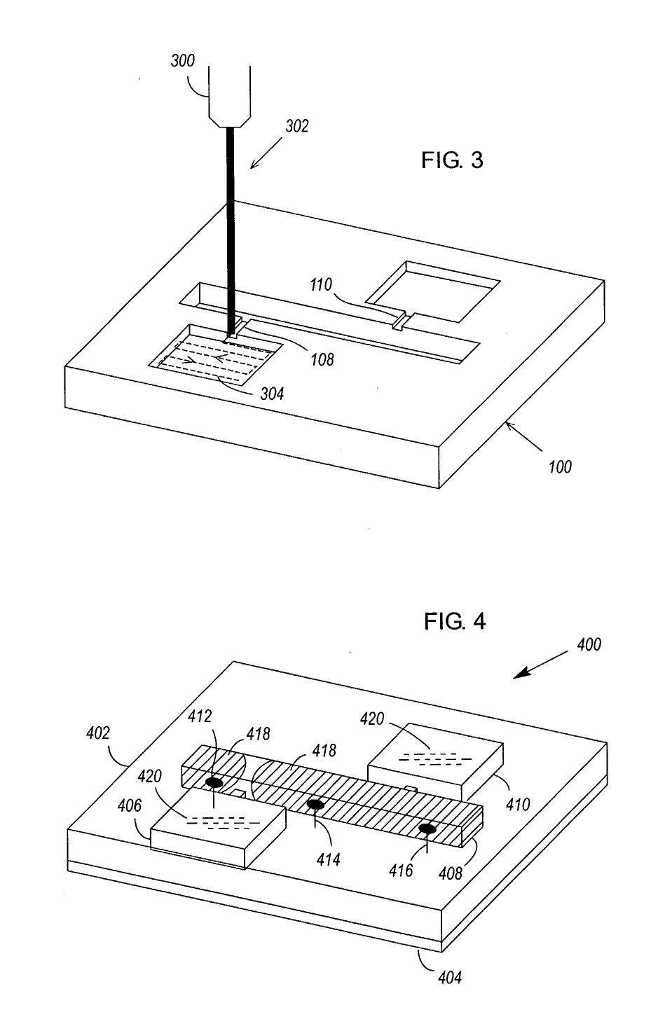

FIG. 3 illustrates how channel plate features 102-110 such as those illustrated in FIGS. 1 and 2 can be laser cut into a channel plate 100. To begin, the power of a laser 300 is regulated to control the cutting depth of a laser beam 302. The beam 302 is then moved into position over a channel plate 100 and moved (e.g., in the direction of arrow 304) to cut a feature 108 into the channel plate 100. If channel features 102-110 are cut to varying depths, the power of the beam 302 may need to be adjusted before different ones of the features 102-110 are cut. If the beam 302 has an adjustable width, the width of the beam 302 may also need to be adjusted as different features 102-110 are cut into channel plate 100. Alternatively, multiple passes of the beam 302 may be needed to cut a single feature “to width” (see arrow 304 in FIG. 3).

If the channel plate 100 is formed of glass, ceramic, or polymer, the channel plate 100 may, by way of example, be cut with a YAG or excimer laser. An example of a YAG laser is the Nd-YAG laser cutting system manufactured by Enlight Technologies, Inc. of Branchburg, N.J. USA. Exemplary Excimer lasers are manufactured by J. P. Sercel Associates, Inc. (JPSA) of Hollis, N.H., USA. If the channel plate 100 is formed of metal, the channel plate 100 may, by way of example, be cut with a CO₂ or Excimer laser. Examplary CO2 lasers are manufactured by PRC Laser of Landing, N.J., USA.

FIG. 4 illustrates a first exemplary embodiment of a switch 400. The switch 400 comprises a channel plate 402 defining at least a portion of a number of cavities 406, 408, 410, a first cavity of which is defined by a laser cut channel in the channel plate 402. The remaining portions of the cavities 406-410, if any, may be defined by a substrate 404 to which the channel plate 402 is sealed. Exposed within one or more of the cavities are a plurality of electrodes 412, 414, 416. A switching fluid 418 (e.g., a conductive liquid metal such as mercury) held within one or more of the cavities serves to open and close at least a pair of the plurality of electrodes 412-416 in response to forces that are applied to the switching fluid 418. An actuating fluid 420 (e.g., an inert gas or liquid) held within one or more of the cavities serves to apply the forces to the switching fluid 418.

In one embodiment of the switch 400, the forces applied to the switching fluid 418 result from pressure changes in the actuating fluid 420. The pressure changes in the actuating fluid 420 impart pressure changes to the switching fluid 418, and thereby cause the switching fluid 418 to change form, move, part, etc. In FIG. 4, the pressure of the actuating fluid 420 held in cavity 406 applies a force to part the switching fluid 418 as illustrated. In this state, the rightmost pair of electrodes 414, 416 of the switch 400 are coupled to one another. If the pressure of the actuating fluid 420 held in cavity 406 is relieved, and the pressure of the actuating fluid 420 held in cavity 410 is increased, the switching fluid 418 can be forced to part and merge so that electrodes 414 and 416 are decoupled and electrodes 412 and 414 are coupled.

By way of example, pressure changes in the actuating fluid 420 may be achieved by means of heating the actuating fluid 420, or by means of piezoelectric pumping. The former is described in U.S. Pat. No. 6,323,447 of Kondoh et al. entitled “Electrical Contact Breaker Switch, Integrated Electrical Contact Breaker Switch, and Electrical Contact Switching Method”, which is hereby incorporated by reference for all that it discloses. The latter is described in U.S. patent application Ser. No. 10/137,691 of Marvin Glenn Wong filed May 2, 2002 and entitled “A Piezoelectrically Actuated Liquid Metal Switch”, which is also incorporated by reference for all that it discloses. Although the above referenced patent and patent application disclose the movement of a switching fluid by means of dual push/pull actuating fluid cavities, a single push/pull actuating fluid cavity might suffice if significant enough push/pull pressure changes could be imparted to a switching fluid from such a cavity. In such an arrangement, the channel plate for the switch could be constructed as disclosed herein.

The channel plate 402 of the switch 400 may have a plurality of laser cut channels 102-110 therein, as illustrated in FIGS. 1-3. In one embodiment of the switch 400, the first laser cut channel in the channel plate 402 defines at least a portion of the one or more cavities 408 that hold the switching fluid 418. A second channel (or channels) may be laser cut into the channel plate 402 so as to define at least a portion of the one or more cavities 406, 410 that hold the actuating fluid 420. A third channel (or channels) may be laser cut into the channel plate 402 so as to define at least a portion of one or more cavities that connect the cavities 406-410 holding the switching and actuating fluids 418, 420.

Additional details concerning the construction and operation of a switch such as that which is illustrated in FIG. 4 may be found in the aforementioned patent of Kondoh et al. and patent application of Marvin Wong.

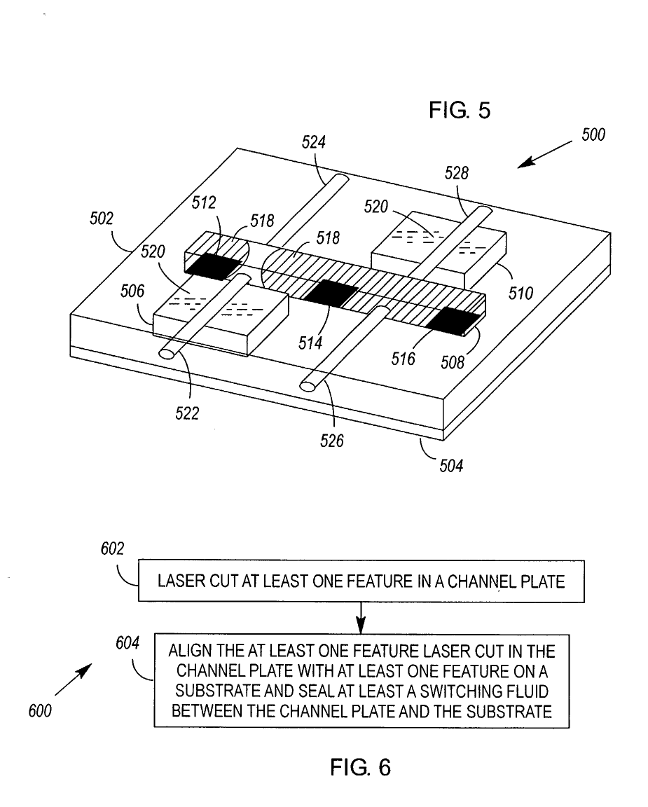

FIG. 5 illustrates a second exemplary embodiment of a switch 500. The switch 500 comprises a channel plate 502 defining at least a portion of a number of cavities 506, 508, 510, a first cavity of which is defined by a laser cut channel in the channel plate 502. The remaining portions of the cavities 506-510, if any, may be defined by a substrate 504 to which the channel plate 502 is sealed. Exposed within one or more of the cavities are a plurality of wettable pads 512-516. A switching fluid 518 (e.g., a liquid metal such as mercury) is wettable to the pads 512-516 and is held within one or more of the cavities. The switching fluid 518 serves to open and block light paths 522/524, 526/528 through one or more of the cavities, in response to forces that are applied to the switching fluid 518. By way of example, the light paths may be defined by waveguides 522-528 that are aligned with translucent windows in the cavity 508 holding the switching fluid. Blocking of the light paths 522/524, 526/528 may be achieved by virtue of the switching fluid 518 being opaque. An actuating fluid 520 (e.g., an inert gas or liquid) held within one or more of the cavities serves to apply the forces to the switching fluid 518.

Forces may be applied to the switching and actuating fluids 518, 520 in the same manner that they are applied to the switching and actuating fluids 418, 420 in FIG. 4.

The channel plate 502 of the switch 500 may have a plurality of laser cut channels 102-110 therein, as illustrated in FIGS. 1-3. In one embodiment of the switch 500, the first laser cut channel in the channel plate 502 defines at least a portion of the one or more cavities 508 that hold the switching fluid 518. A second channel (or channels) may be laser cut into the channel plate 502 so as to define at least a portion of the one or more cavities 506, 510 that hold the actuating fluid 520. A third channel (or channels) may be laser cut into the channel plate 502 so as to define at least a portion of one or more cavities that connect the cavities 506-510 holding the switching and actuating fluids 518, 520.

Additional details concerning the construction and operation of a switch such as that which is illustrated in FIG. 5 may be found in the aforementioned patent of Kondoh et al. and patent application of Marvin Wong.

A channel plate of the type disclosed in FIGS. 1 & 2 is not limited to use with the switches 400, 500 disclosed in FIGS. 4 & 5 and may be used in conjunction with other forms of switches that comprise, for example, 1) a channel plate defining at least a portion of a number of cavities, a first cavity of which is defined by a laser cut channel in the channel plate, and 2) a switching fluid, held within one or more of the cavities, that is movable between at least first and second switch states in response to forces that are applied to the switching fluid.

An exemplary method 600 for making a fluid-based switch is illustrated in FIG. 6. The method 600 commences with the laser cutting 602 of at least one feature into a channel plate. Optionally, portions of the channel plate may then be metallized (e.g., via sputtering or evaporating through a shadow mask, or via etching through a photoresist). Finally, features formed in the channel plate are aligned with features formed on a substrate, and at least a switching fluid (and possibly an actuating fluid) is sealed 604 between the channel plate and a substrate.

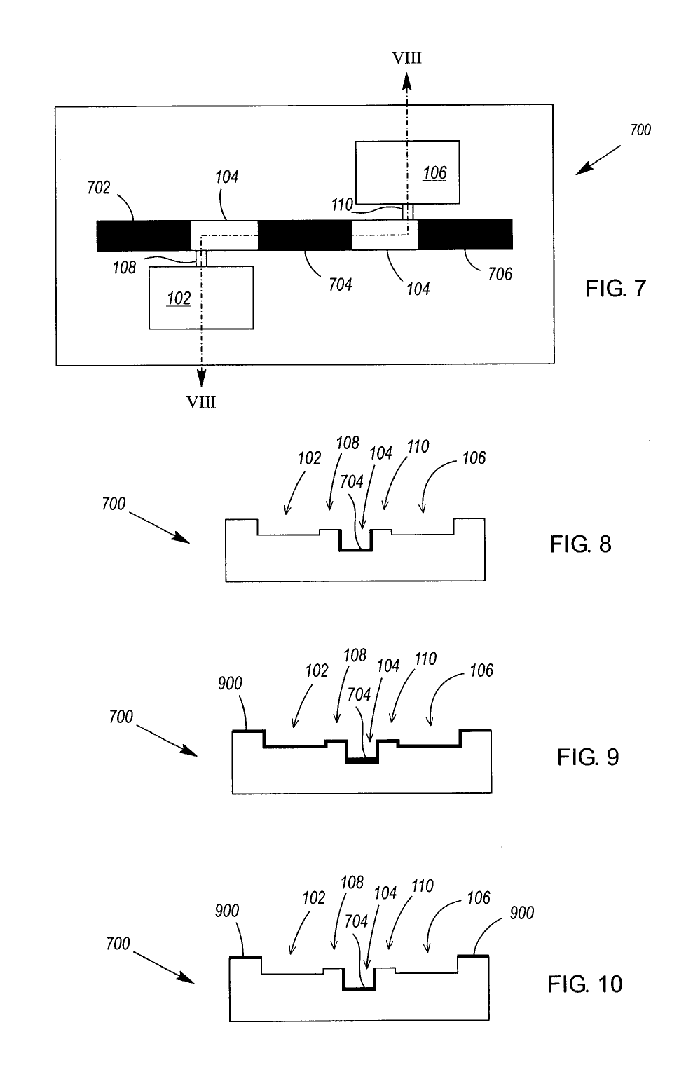

FIGS. 7 & 8 illustrate how portions of a channel plate 700 similar to that which is illustrated in FIGS. 1 & 2 may be metallized for the purpose of creating “seal belts” 702, 704, 706. The creation of seal belts 702-706 within a switching fluid channel 104 provides additional surface areas to which a switching fluid may wet. This not only helps in latching the various states that a switching fluid can assume, but also helps to create a sealed chamber from which the switching fluid cannot escape, and within which the switching fluid may be more easily pumped (i.e., during switch state changes).

One way to seal a switching fluid between a channel plate and a substrate is by means of an adhesive applied to the channel plate. FIGS. 9 & 10 therefore illustrate how an adhesive (such as the Cytop™ adhesive manufactured by Asahi Glass Co., Ltd. of Tokyo, Japan) may be applied to the FIG. 8 channel plate 700. The adhesive 900 may be spin-coated or spray coated onto the channel plate 700 and cured. Laser ablation may then be used to remove the adhesive from channels and/or other channel plate features (see FIG. 10). Preferably, the ablation is performed using the same laser 300 that is used for cutting channels 102-110 in the channel plate 100, thereby reducing the number of systems that are needed to manufacture a switch that incorporates the channel plate 100.

Although FIGS. 7-10 disclose the creation of seal belts 702-706 on a channel plate 700, followed by the application of an adhesive 900 to the channel plate 700, these processes could alternately be reversed.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

What is claimed is:

1. A switch, comprising:
a) a channel plate defining at least a portion of a number of cavities, a first cavity of which is defined by a laser cut channel in the channel plate;
b) a plurality of electrodes exposed within one or more of the cavities;
c) a switching fluid, held within one or more of the cavities, that serves to open and close at least a pair of the plurality of electrodes in response to forces that are applied to the switching fluid; and
d) an actuating fluid, held within one or more of the cavities, that serves to apply said forces to the switching fluid.

2. The switch of claim 1, wherein the laser cut channel defines at least a portion of the one or more cavities that hold the switching fluid.

3. The switch of claim 2, wherein the channel plate comprises a second laser cut channel that defines at least a portion of the one or more cavities that hold the actuating fluid.

4. The switch of claim 2, wherein the channel plate further comprises a pair of laser cut channels that define at least portions of the one or more cavities that hold the actuating fluid, and a pair of laser cut channels that define at least portions of one or more cavities that connect the cavities holding the switching and actuating fluids.

5. A switch, comprising:
a) a channel plate defining at least a portion of a number of cavities, a first cavity of which is defined by a laser cut channel in the channel plate;
b) a plurality of wettable pads exposed within one or more of the cavities;
c) a switching fluid, wettable to said pads and held within one or more of the cavities, that serves to open and block light paths through one or more of the cavities in response to forces that are applied to the switching fluid; and
d) an actuating fluid, held within one or more of the cavities, that serves to apply said forces to the switching fluid.

6. The switch of claim 5, wherein the laser cut channel defines at least a portion of the one or more cavities that hold the switching fluid.

7. The switch of claim 6, wherein the channel plate comprises a second laser cut channel that defines at least a portion of the one or more cavities that hold the actuating fluid.

8. The switch of claim 6, wherein the channel plate further comprises a pair of laser cut channels that define at least portions of the one or more cavities that hold the actuating fluid, and a pair of laser cut channels that define at least portions of one or more cavities that connect the cavities holding the switching and actuating fluids.

9. A switch, comprising:
a) a channel plate defining at least a portion of a number of cavities, a first cavity of which is defined by a laser cut channel in the channel plate;
b) a switching fluid, held within one or more of the cavities, that is movable between at least first and second switch states in response to forces that are applied to the switching fluid.

10. The switch of claim 9, wherein the laser cut channel defines at least a portion of the one or more cavities that hold the switching fluid.

11. The switch of claim 10, wherein a second laser cut channel in the channel plate defines at least a portion of a cavity from which said forces are applied to the switching fluid.

12. A method for making a switch, comprising:
a) laser cutting at least one feature into a channel plate; and
b) aligning the at least one feature cut in the channel plate with at least one feature on a substrate and sealing at least a switching fluid between the channel plate and the substrate.

13. The method of claim 12, further comprising:
a) applying an adhesive to the channel plate;
b) laser ablating the adhesive from the at least one feature cut in the channel plate; and
c) using the adhesive to seal the switching fluid between the channel plate and the substrate.

14. The method of claim 13, wherein the adhesive is Cytop.

15. The method of claim 13, wherein the same laser is used for the laser cutting and laser ablating.

16. The method of claim 12, wherein the channel plate is a ceramic channel plate and the laser is a YAG or excimer laser.

17. The method of claim 12, wherein the channel plate is a glass channel plate and the laser is a YAG or excimer laser.

18. The method of claim 12, wherein the channel plate is a polymer channel plate and the laser is a YAG or excimer laser.

19. The method of claim 12, wherein the channel plate is a metallic channel plate and the laser is a CO₂ or excimer laser.

20. The method of claim 12, wherein a first feature that is laser cut into the channel plate is a channel for holding the switching fluid.

21. The method of claim 20, wherein a second feature that is laser cut into the channel plate is an actuating fluid channel, and wherein the method further comprises sealing an actuating fluid between the channel plate and the substrate.

22. The method of claim 21, further comprising, cutting the switching and actuating fluid channels to different depths by adjusting the power of a laser cutter.

23. The method of claim 12, wherein the features that are laser cut into the channel plate comprise a channel for holding the switching fluid, a pair of channels for holding an actuating fluid, and a pair of channels connecting corresponding ones of the channels holding the actuating fluid to the channel holding the switching fluid; the method further comprising sealing an actuating fluid between the channel plate and the substrate.
